(19) United States
(12) Patent Application Publication
(10) Pub. No.: US 2008/0307208 A1
(43) Pub. Date: Dec. 11, 2008

(54) Application specific processor having multiple contexts

(75) Inventors: Michael James, Longmont, CO (US); Scott Richmond, Boulder, CO (US)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/810,821

(22) Filed: Jun. 7, 2007

(51) Int. Cl. G06F 7/38

(52) U.S. Cl. 712/228; 712/E09.001

(57) ABSTRACT

An application specific processor executes multiple dedicated applications in a system having a main control processor for controlling the operation of the system. The application specific processor includes a first context for executing a corresponding first application and a second context for executing a corresponding second application. An instruction memory outputs instructions for executing the first and second applications, and a context switch instruction for switching from one context to the other context. Context is switched in response to the context switch instruction while executing the first or second application.

### FIELD OF INVENTION

The present invention relates to application specific processors, and in particular, to an application specific processor adapted to switch between multiple contexts for performing various tasks.

### BACKGROUND OF THE INVENTION

Application specific processors (ASPs) are often employed in hard disk controllers (HDC) of data storage systems for performing specific tasks such as controlling a buffer or a disk formatter, for example. The ASPs may also enable transmission of data to and from a host device connected to the HDC. Typically, one ASP is provided for operating a particular application. For example, some host devices have redundant ports for transmitting and receiving data to and from the HDC. Each of these ports will have an ASP for transmitting data and another ASP for receiving data (see FIG. 6). Thus, four ASPs are used in a host interface (HIF) of the HDC for transmitting and receiving data through two ports.

Using one dedicated ASP for each application or task, at times, is disadvantageous. This is because the ASPs normally operate so fast that they often start a task and sit idle while waiting for the task to be completed. As such, the ASPs are under utilized, which unnecessarily increases the cost of the final system.

### SUMMARY OF THE INVENTION

The present invention is directed to an application specific processor for executing multiple dedicated applications in a system having a main control processor for controlling the operation of the system. The application specific processor includes a first context for executing a corresponding first application and a second context for executing a corresponding second application. An instruction memory outputs instructions for executing the first and second applications, and a context switch instruction for switching from one context to the other context. Context is switched in response to the context switch instruction while executing the first or second application.

### BRIEF DESCRIPTION OF THE DRAWINGS

FIG. 1 is a block diagram illustrating the generic environment in which an application specific processor (ASP) is adapted to be implemented in accordance with one embodiment of the present invention;

FIG. 2 is a block diagram illustrating one implementation of the present invention for data transmission between a host and a host interface;

FIG. 3 is a block diagram of the ASP shown in FIG. 1 in accordance with one embodiment of the present invention;

FIG. 4 is an illustration of a single memory in the ASP supporting two contexts;

FIG. 5 a block diagram of the ASP shown in FIG. 1 in accordance with another embodiment of the present invention;

FIG. 6 is an illustration of a single memory in the ASP supporting four contexts;

FIG. 7 is a flowchart describing a process for switching between different contexts in accordance with one embodiment of the present invention; and

FIG. 8 is a block diagram illustrating an example of an environment in which conventional application specific processors are employed.

### DETAILED DESCRIPTION OF THE PREFERRED EMBODIMENTS

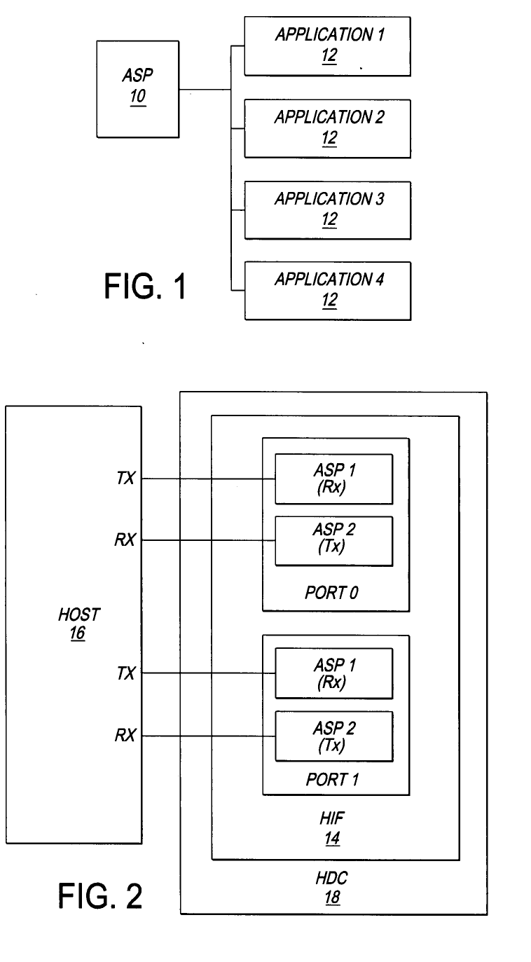

Turning to FIG. 1, and in accordance with one embodiment of the present invention, a dedicated application specific processor (ASP) 10 is adapted and configured to perform the operations of at least two applications 12 (four shown in FIG. 1). The ASP 10 switches operations between the applications 12 so that the operations are executed separately. The applications 12 may, for example, be a buffer controller and a disk formatter and/or host ports in a hard disk controller (HDC).

FIG. 2 shows the ASP 10 of the present invention being provided in a host interface (HIF) 14 for transmitting and receiving data to and from a host 16 connected to a hard disk controller (HDC) 18 of a data storage system (not shown). The HIF 14 includes two ports 0 and 1, each for transmitting and receiving data to and from the host 16. One ASP 10 is provided for transmitting data for both ports 0 and 1, and a second ASP for receiving data for both ports 0 and 1. In a conventional data storage system, as shown in FIG. 6, four ASPs would be required, instead of two as in the present invention.

It should be understood that while the ASP 10 of the present invention is described herein with respect to a data storage system, its use is not confined or limited to this environment. The ASP 10 of the present invention can be used in any environment, such as a network processor or a USB hub, for example, where two or more dedicated applications or tasks can be operated by a single ASP.

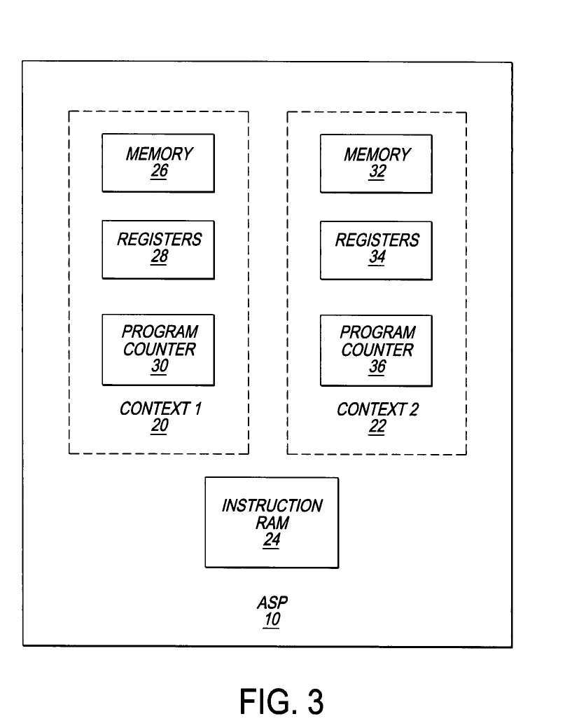

Referring to FIG. 3, a description of the present ASP 10 having two contexts 20, 22 is given to simplify explanation. It should be understood, however that the same description applies to the ASP 10 having more than two contexts. The ASP 10 includes two contexts 20, 22 which perform specific predefined operations, and a shared instruction RAM 24. In the example shown in FIG. 2, the context 20 would handle data transmission for port 0, and the context 22 for port 1.

The first context 20 includes a memory 26 for storage of permanent and temporary variables used in the operation associated with the first context, a number of registers 28 for configuration and control and a program counter 30 used to address or track instructions in the instruction RAM 24. The second context 22 also includes a memory 32, a number of registers 34 and a program counter 36, which perform the same functions as the components of the first context 20, but with respect the application corresponding to the second context 22. The memories 26 and 32 are preferably in the form of a RAM.

The instruction RAM 24 includes instruction sequences for enabling the contexts 20, 22 to carry out their intended functions. In the embodiment in which the ASPs 10 perform data transmission for ports 0 and 1, as shown in FIG. 2, the instructions may include moving data in and out of the registers 28, 34, reading from or storing data in the memories 26, 32, calculating addresses or sizes, etc. The instruction RAM 24 also includes instructions for going into a polling or idle loop in which the contexts 20,22 will sit and wait for a particular task to be completed.

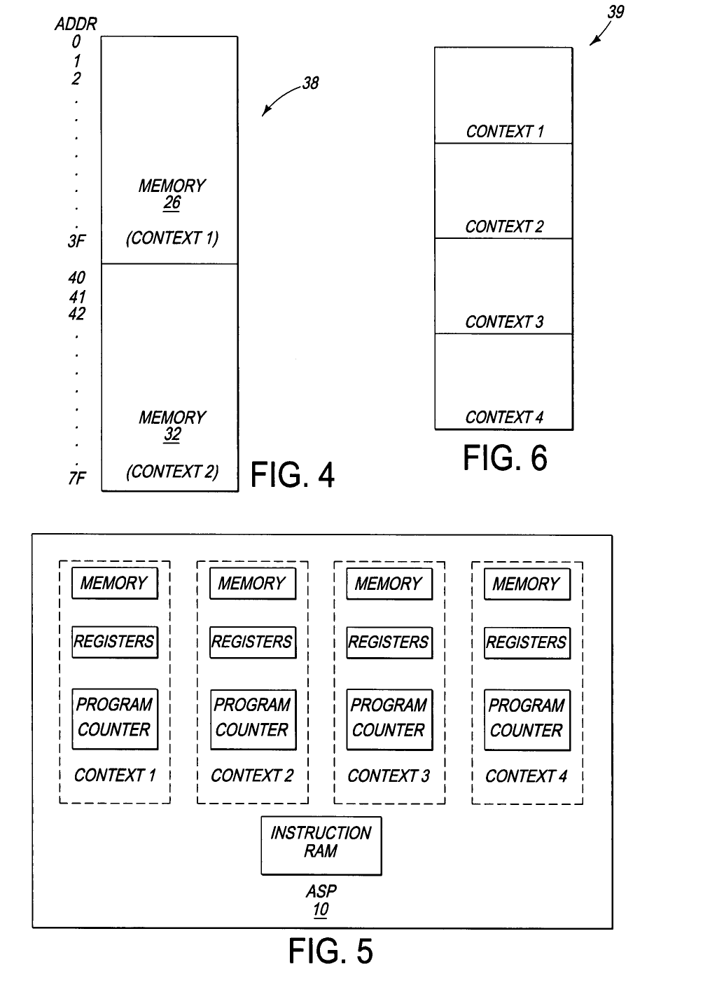

It should be understood that while the registers 28 and 34 are shown as physically residing in the ASP 10, they may be located remotely outside the ASP. For example, if the ASPs 10 are provided in the HIF 14, as in the embodiment shown in FIG. 2, the registers 28 and 34 may be located in ports 0 and 1 of the HIF. Also, while FIG. 3 shows the memories 20, 26 being two separate components, they can be provided on a single RAM and divided into two parts, thereby saving space on the chip on which the ASP 10 is fabricated. FIG. 4 shows a single RAM 38 incorporating memories 26 and 32 from both contexts 20 and 22, the lower address space being used for the first context and the upper address space for the second context, for example.

In FIG. 5, the ASP 10 having four contexts 1-4 is shown. Each context 1-4 includes a memory, registers, program counter and a common instruction RAM. Having four contexts enables the ASP 10 to separately operate four operations or applications. For example, contexts 1-4 may act as a buffer controller and a disk formatter in addition to two host ports. The instruction RAM of FIG. 5, includes instruction sequences for enabling the four contexts 1-4 to carry out their intended functions.

As in the embodiment of the ASP 10 having two contexts 20, 22, the four registers of the contexts 1-4 may be located remotely outside the ASP, and the memories of the contexts 1-4 may be provided on a single RAM which is divided into four parts, thereby saving space on the chip on which the ASP is fabricated. FIG. 6 shows an embodiment of a single RAM 39 incorporating all four memories from the four contexts 1-4.

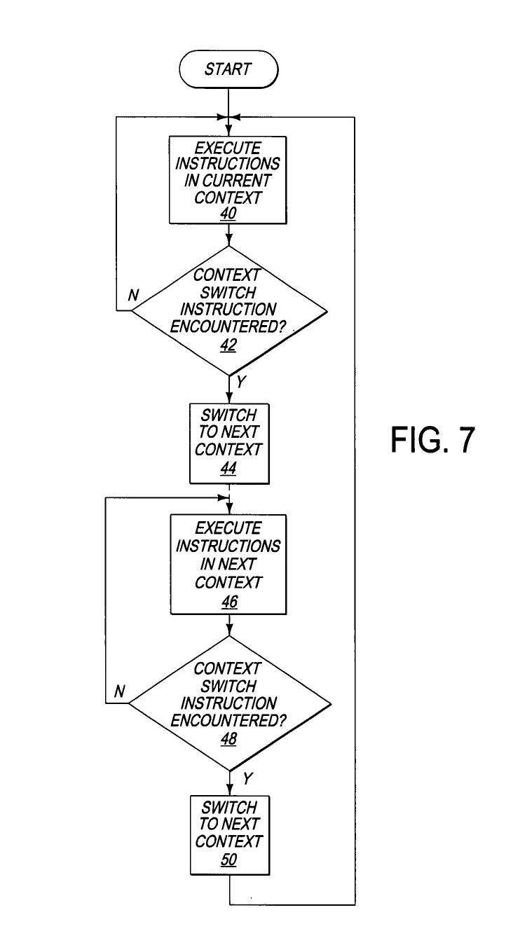

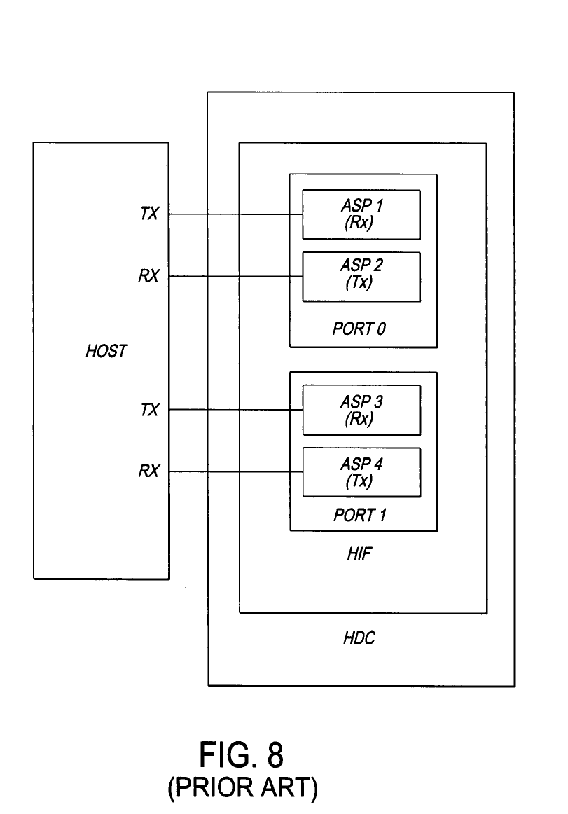

Turning now to FIG. 7, the operation of the ASP 10 is described in accordance with one preferred embodiment. At the start, one of the contexts (any of contexts 20, 22 in FIG. 3 or contexts 1-4 in FIG. 5) will execute the instructions stored in the instruction RAM 24 directed to the operation of the application or task corresponding to that context (block 40). If a context switch instruction is not encountered during a polling or idle loop, or times of inactivity or while waiting for an event to occur during the operation of the application (block 42), the current context will continue to execute the instructions associated with the application corresponding to this context until completed (block 40). If, however, the current context does encounter a context switch instruction (block 42), the ASP 10 switches to the next context indicated in the context switch instruction (block 44).

The next context (which becomes the current context) then begins executing instructions associated with the corresponding application (block 46) until a context switch instruction is encountered by this context during a polling or idle loop, or times of inactivity or while waiting for an event to occur during the operation of the application (block 48). This causes the ASP 10 to switch to the next context indicated in the context switch instruction (block 50), which may or may not be the same first context in which the ASP 10 began the initial operation.

If the next context is the same as the one in which the ASP 10 began its operation, it then resumes executing instructions associated with the first application from where it left off when it previously encountered the context switch instruction (block 40). If not, the next current context will begin executing instructions associated with its corresponding application (block 40) until a context switch instruction is encountered during a polling or idle loop, or times of inactivity or while waiting for an event to occur during the operation of the application (block 42), and the process repeats as described above.

Moreover, the case where the ASP 10 is employed to switch context between the same type of application (for example, redundant ports to transmit or receive data), the instruction sequence stored in the instruction RAM 24 may be identical, and the pointers from the program counters may be pointing to the same place in the instruction RAM 24. If however, the contexts are configured to operate different applications, the pointers in the program counters would start at different locations in the instruction RAM 24.

The embodiments and examples set forth herein were presented in order to best explain the present invention and its practical application and to thereby enable those skilled in the art to make and use the invention. Those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the forthcoming claims.

Various features of the invention are set forth in the appended claims.

What is claimed is:

1. An application specific processor for executing multiple dedicated applications in a system having a main control processor for controlling the operation of the system, the application specific processor comprising:
a first context for executing a corresponding first application;
a second context for executing a corresponding second application; and
an instruction memory for outputting instructions for executing the first and second applications, and a context switch instruction for switching from one of the first and second contexts to the other of the first and second contexts;
wherein the one of the first and second contexts is switched to the other of the first and second contexts responsive to the context switch instruction output by the instruction memory while executing the first or second application.

2. The application specific process as defined in claim 1, wherein the context switch instruction is output during a loop operation encountered while executing the first or second application.

3. The application specific process as defined in claim 1, wherein the context switch instruction is output during times of inactivity or while waiting for an event to occur during the operation of the first or second application.

4. The application specific processor as defined in claim 1, wherein the first context includes a first memory storing variables associated with the first application, and the second context includes a second memory storing variables associated the second application.

5. The application specific processor as defined in claim 4, wherein the first and second memories are provided on a shared memory device.

6. The application specific processor as defined in claim 5, where the shared memory device is a RAM.

7. The application specific processor as defined in claim 4, wherein the first context further includes a first program counter for tracking instructions associated with the first application, and the second context includes a second program counter for tracking instructions associated with the second application.

8. The application specific processor as defined in claim 7, wherein the first context further includes a first set of registers for configuration and control associated with the first application, and the second context includes a second set of registers for configuration and control associated with the second application.

9. The application specific processor as defined in claim 6, further comprising:
at least one subsequent context for executing corresponding subsequent applications;
wherein the instruction memory outputs instructions for executing the first, second and at least one subsequent applications, and the context switch instruction enables switching from one of the first, second and at least one subsequent context to any of the other of the first, second and at least one subsequent context responsive to the context switch instruction output by the instruction memory while executing the first, second or at least one subsequent context.

10. The application specific process as defined in claim 9, wherein the context switch instruction is output during a loop operation encountered while executing the first, second or at least one subsequent context.

11. The application specific process as defined in claim 1, wherein the context switch instruction is output during times of inactivity or while waiting for an event to occur during the operation of the first or second application.

12. A method for operating multiple applications using a single application specific processor in a system having a main control processor for controlling the operation of the system, comprising:
executing a first application using a corresponding first context in the application specific processor;
switching to a second context in the application specific processor responsive to an encounter of a first loop operation containing a first context switch instruction during the execution of the first application; and
executing the second application using the second context;
wherein the first context switch instruction and instructions for executing the first and second applications are output by a shared instruction memory in the application specific processor.

13. The method as defined in claim 12, further comprising switching to a next context from the second context responsive to an encounter of a second loop operation containing a second context switch instruction during the execution of the second application.

14. The method as defined in claim 13, wherein the next context is the first context.

15. The method as defined in claim 13, wherein the next context is a third context for executing a corresponding third application.

16. The method as defined in claim 13, wherein second context switch instruction is output by the shared instruction memory.

17. The method as defined in claim 12, wherein the first application is executed using stored first variables associated with the first instructions, and the second application is executed using stored second variables associated with the second application

18. The method as defined in claim 17, wherein the first and second variables are stored in a common memory.

19. An application specific processor for executing multiple dedicated applications in a disk storage system including a hard disk controller having a main control processor for controlling the disk storage system and transmission of data to and from a host device, the application specific processor comprising:
a first context for executing a corresponding first application;
a second context for executing a corresponding second application; and
an instruction memory for outputting instructions for executing the first and second applications, and a context switch instruction for switching from one of the first and second contexts to the other of the first and second contexts;
wherein the one of the first and second contexts is switched to the other of the first and second contexts responsive to an encounter of a loop operation containing the context switch instruction while executing the first or second application.

20. The application specific processor as defined in claim 19, wherein the first context transmits data to the host device through a first and second transmission ports, and the second context receives data to or from the host device through the first and second transmission ports.

21. The application specific processor as defined in claim 19, wherein the buffer management application and the second application is a disk formatting application.

22. The application specific processor as defined in claim 19, further comprising:
at least one subsequent context for executing corresponding subsequent applications;
wherein the instruction memory outputs instructions for executing the first, second and at least one subsequent applications, and the context switch instruction enables switching from one of the first, second and at least one subsequent context to any of the other of the first, second and at least one subsequent context responsive to an encounter of a loop operation containing the context switch instruction while executing the first, second or at least one subsequent context.
